(19) United States
(12) Patent Application Publication
(10) Pub. No.: US 2014/0293399 A1
(43) Pub. Date: Oct. 2, 2014

(54) ELECTROPHORESIS ELEMENT, DISPLAY APPARATUS AND ELECTRONIC DEVICE

(71) Applicant: Sony Corporation, Tokyo (JP)

(72) Inventors: Nozomi KIMURA, Kanagawa (JP); Keisuke SHIMIZU, Tokyo (JP); Aya SHUTO, Tokyo (JP)

(73) Assignee: Sony Corporation, Tokyo (JP)

(21) Appl. No.: 14/201,145

(22) Filed: Mar. 7, 2014

(30) Foreign Application Priority Data
Mar. 26, 2013 (JP) 2013-063281

(51) Int. Cl. G02F 1/167

(52) U.S. Cl. CPC G02F 1/167
USPC 359/296

(57) ABSTRACT

There is provided an electrophoresis element including a first base material, a second base material disposed facing to the first base material, insulation liquid layers disposed between the first base material and the second base material, a porous layer disposed in the insulation liquid layers and electrophoresis particles disposed in the insulation liquid layers, at least one of the first base material and the second base material having a light transmittance, graphene being disposed on at least a part of the surface of one of the first base material and the second base material having the light transmittance that is in contact with the insulation liquid layers; a display apparatus using the electrophoresis element and an electronic device using the display apparatus.

### CROSS REFERENCES TO RELATED APPLICATIONS

The present application claims priority to Japanese Priority Patent Application JP 2013-063281 filed in the Japan Patent Office on Mar. 26, 2013, the entire content of which is hereby incorporated by reference.

### BACKGROUND

The present disclosure relates to an electrophoresis element, a display apparatus using the electrophoresis element, and an electronic device using the display apparatus.

### SUMMARY

In recent years, with mobile devices including mobile phones or personal digital assistances becoming more and more widely used, there is much demand for a display apparatus with low power consumption and high image quality. In particular, a personal digital assistance for reading text information for a prolonged time, i.e., an electronic book reader, gathers attentions. A reflection display is the most promising device having a good display quality suitable for its application.

Among a number of the reflection displays, an electrophoresis display with low power consumption and high-speed responsiveness is already commercially available. Recently, a display method of the electrophoresis display is under various reviews.

In the electrophoresis display widely used, two types of charged particles having different light reflection properties are dispersed in insulation liquid and migrate by the electric field. As the two types of the charged particles have opposite polarities, distribution statuses of the charged particles change by the electric field.

In other electrophoresis display, it is proposed that a porous layer is disposed in the insulation liquid, the charged particles are dispersed, and the charged particles migrate by the electric field through pores of the porous layer to display images on a display section.

FIG. 14 is a sectional view showing an example of the electrophoresis display in the related art. As shown in FIG. 14, an electrophoresis element 100 includes insulation liquid layers 111 sandwiched between a transparent base material 101 and a base material 121. On the transparent base material 101 at a side of the insulation liquid layer 111, a counter electrode 102 made of an ITO film is disposed. On the other hand, on the base material 121 at a side of the insulation liquid 111, thin film transistors (TFTs) 122 are disposed. By the TFTs 122, pixel electrodes 125 are driven. Between the TFTs 122 and the pixel electrodes 125, a protection layer 123 and a planarizing insulation layer 124 are sequentially laminated. The insulation liquid layers 111 include a plurality of electrophoresis particles 112 and a porous layer 113 disposed therebetween. The porous layer 113 is a three-dimensional structure formed of fibrous structures. The fibrous structures include a plurality of non-migrating particles having light reflection properties (reflectances) different from those of the electrophoresis particles 112. In this way, by configuring the porous layer 113 of the electrophoresis element 100 with the fibrous structures including the non-migrating particles having the light reflection properties different from those of the electrophoresis particles 112, the display section can have a high contrast (for example, see Patent Document 1).

FIG. 15 is a sectional view showing another example of an electrophoresis element 200 in the related art. In the electrophoresis element 200, a color filter 201 is laminated on a light incident surface of the transparent base material 101 of the electrophoresis element 100. In this way, the light reflected from the display section is transmitted through the color filter 201 and displayed images can be colorized. However, in the electrophoresis element 200, disparities are easily generated by a distance between the color filter 201 and the display section and by refraction caused by the transparent base material 101 and the counter electrode 102 disposed between the color filter 201 and the display section.

And now, graphene is one-atom thick layer of graphite, has high light transmittance and high conductivity, and has been expected as a transparent conductive material or a wiring material.

An electrophoresis display described in Japanese Patent Application Laid-open No. 2012-22296 uses an ITO electrode having low light transmittance as the counter electrode 102. The ITO electrode absorbs most of the light incident on the display section and the light reflected from the display section. Such a light loss by the ITO electrode reduces brightness and contrast in a display area of the electrophoresis display, thereby undesirably dulling the display.

It is desirable to provide an electrophoresis element being capable of providing high brightness and high contrast.

It is further desirable to provide a display apparatus using the above-described excellent electrophoresis element.

It is still further desirable to provide a high performance electronic device using the above-described excellent display apparatus.

According to an embodiment of the present disclosure, there is provided an electrophoresis element, including:

a first base material;

a second base material disposed facing to the first base material;

insulation liquid layers disposed between the first base material and the second base material;

a porous layer disposed in the insulation liquid layers; and

electrophoresis particles disposed in the insulation liquid layers,

at least one of the first base material and the second base material having a light transmittance, and graphene being disposed on at least a part of the surface of one of the first base material and the second base material having the light transmittance that is in contact with the insulation liquid layers.

According to an embodiment of the present disclosure, there is also provided a display apparatus, including at least one electrophoresis element, the electrophoresis element, including:

a first base material;

a second base material disposed facing to the first base material;

insulation liquid layers disposed between the first base material and the second base material;

a porous layer disposed in the insulation liquid layers; and

electrophoresis particles disposed in the insulation liquid layers,

at least one of the first base material and the second base material having a light transmittance, graphene being disposed on at least a part of the surface of one of the first base material and the second base material having the light transmittance that is in contact with the insulation liquid layers.

According to an embodiment of the present disclosure, there is further provided an electronic device, including at least one electrophoresis element, the electrophoresis element, including:

a first base material;

a second base material disposed facing to the first base material;

insulation liquid layers disposed between the first base material and the second base material;

a porous layer disposed in the insulation liquid layers; and

electrophoresis particles disposed in the insulation liquid layers,

at least one of the first base material and the second base material having a light transmittance, graphene being disposed on at least a part of the surface of one of the first base material and the second base material having the light transmittance that is in contact with the insulation liquid layers.

In the present disclosure, the base material is basically not limited as long as the base material has a surface on which other material can be laminated. For example, the base material may be a substrate or a wafer having stiffness, or may be a thin plate, a thin film or a film having flexibility. The flexibility is desirably such that the base material can be bent by human power. The base material may or may not have light transmittance. As an example, the base material is desirably made of a transparent material having good light transmittance when the base material is used at a light incident side of the electrophoresis element.

The insulation liquid is basically not limited as long as the liquid has electrical insulation properties. Desirably, the insulation liquid has low viscosity. With the low viscosity, migrating properties of the electrophoresis particles are improved and a response speed of the display section is improved. Also, as viscous resistance is decreased when the electrophoresis particles are migrated, necessary energy to migrate the electrophoresis particles is decreased, which leads to lower power consumption. In addition, the insulation liquid desirably has a low refractive index. With the low refractive index, a difference between the refractive index of the insulation liquid and the refractive index of the porous layer becomes great, and reflectance at a light reflection surface of the porous layer is increased. The insulation liquid is at least one organic solvent selected from the known organic solvents. Examples of the organic solvents include paraffin and isoparaffin. The insulation liquid may include additives as appropriate. Examples of the additives include a coloring agent, a charge controlling agent, a dispersion stabilizer, a viscosity modifier, a surfactant and a resin.

The electrophoresis particles are basically not limited as long as they are charged particles that can be migrated by the electric field. Desirably, the particles can be migrated through the porous layer. Examples of the electrophoresis particles include at least one selected from the group consisting of particles (powder) such as organic pigment, inorganic pigment, dye, carbon materials, metal materials, metal oxides, glass and polymer materials (resin).

The porous layer is basically not limited as long as it has pores. Desirably, the porous layer has a number of through holes penetrating through both main surfaces. Also it is desirable that the through holes are configured such that the electrophoresis particles can pass through. Examples of the porous layer include a polymer film into which pores are formed by laser drilling, a fabric knitted with synthetic fibers and an open cell porous polymer. In particular, a three-dimensional structure formed of the fibrous structures is desirable. Examples of the three-dimensional structure formed of the fibrous structures include an irregular network structure such as a non-woven fabric. The fibrous structures desirably support non-migrating particles, for example. The fibrous structures are basically not limited as long as they are fibrous substances each having a length sufficiently longer than a diameter. Desirably, in the fibrous structures, the diameter is very short. The desirable materials of the fibrous structures have low reactivity, e.g., photoreactivity, and are chemically stable. Specifically, the fibrous structures are desirably at least one selected from polymer materials and inorganic materials; more specifically, polymer materials, without limitation. When the fibrous structures are formed of a highly reactive material, surfaces of the fibrous structures are desirably covered by any protection layer. The non-migrating particles are basically not limited, and can be selected from the electrophoresis particles listed as appropriate that have the light reflection properties different from those of the electrophoresis particles used for providing a contrast in the display section. Also desirably, the porous layer containing the non-migrating particles can block the electrophoresis particles. The materials of the non-migrating particles for a light display are desirably the same as those for a dark display. Among them, the materials of the non-migrating particles for a light display are metal oxides, for example.

Graphene is basically not limited as long as it includes carbon atoms of at least one graphite layer. Desirably, a graphene film is synthesized by a thermal CVD method where large area films can be formed and the number of the films can be controlled. By forming the graphene film on the transparent base material, it can be used as a transparent conductive base material, a transparent conductive film or a transparent conductive sheet, for example. The transparent conductive film can be used for a variety of electronic devices. Examples of the electronic devices include a display such as a reflective display, an electrophoretic form display (electronic paper), a liquid crystal display (LCD), an organic electroluminescence display (an organic EL display); a touch panel and the like. The transparent conductive film may be used without limitation. The transparent conductive film can be used as an electrode of a solar cell or a dye-sensitized solar cell. The electrode can be a graphene electrode having a transparent base material and a graphene film laminated over the transparent base material. The graphene electrode may have openings. In addition, an antireflection layer may be disposed on at least a part of the graphene, for example. In this case, the antireflection layer is laminated over the graphene electrode.

According to the present disclosure, graphene is used as the counter electrode of the electrophoresis element, instead of ITO. The light incident on the display section and the light reflected from the display section absorbed by the counter electrode, i.e., the ITO film in the related art, can be reduced, thereby providing an electrophoresis element being capable of providing high brightness and high contrast, as compared to the related art. By using the excellent electrophoresis element, a high performance display apparatus can be provided. By using the excellent display apparatus, a high performance electronic device can be provided.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a sectional view showing an electrophoresis element according to a first embodiment;

FIG. 2 is a sectional view showing an initial state of the electrophoresis element according to a first embodiment;

FIG. 3 is a sectional view showing a driving state of the electrophoresis element according to a first embodiment;

FIG. 4 is a plan view showing a graphene electrode according to a second embodiment;

FIG. 5 is a plan view showing a graphene electrode having a transparent layer according to a third embodiment;

FIG. 6 is a sectional view showing an electrophoresis element according to a fourth embodiment;

FIG. 7 is a sectional view showing an electrophoresis element being capable of displaying colors according to a fifth embodiment;

FIGS. 8A and 8B each is a perspective view showing an electronic book to which a display apparatus according to a sixth embodiment is applied;

FIG. 9 is a perspective view showing a TV to which a display apparatus according to a sixth embodiment is applied;

FIGS. 10A and 10B each is a perspective view showing a digital camera to which a display apparatus according to a sixth embodiment is applied;

FIG. 11 is a perspective view showing a notebook-size personal computer to which a display apparatus according to a sixth embodiment;

FIG. 12 is a perspective view showing a video camera to which a display apparatus according to a sixth embodiment is applied;

FIGS. 13A to 13G each is a perspective view showing a mobile phone to which a display apparatus according to a sixth embodiment is applied;

FIG. 14 is a sectional view showing an electrophoresis element in the related art; and

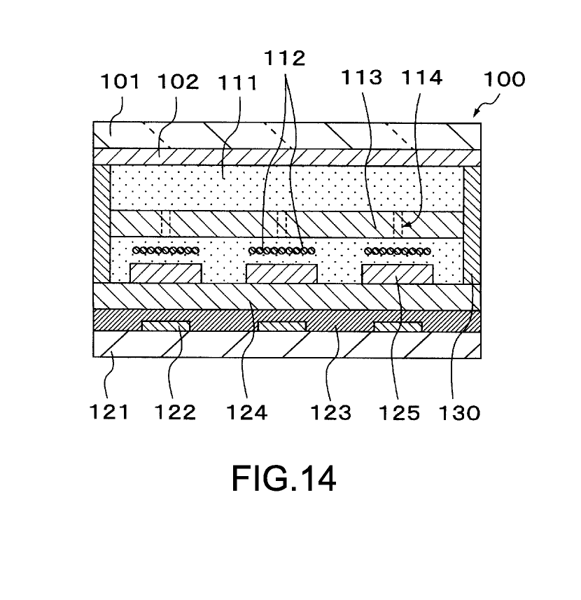

FIG. 15 is a sectional view showing an electrophoresis element being capable of a color display in the related art.

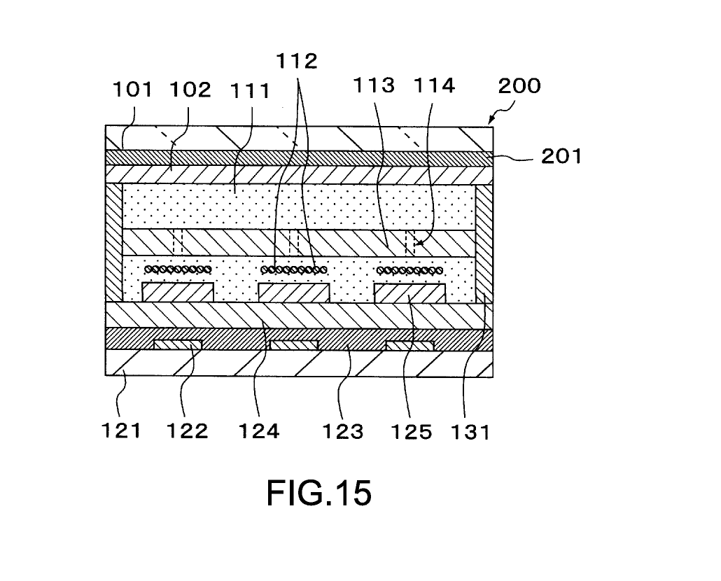

### DETAILED DESCRIPTION

Hereinafter, an embodiment of the present disclosure will be described with reference to the drawings.

The embodiments of the present application will be described in the following order.

1. First Embodiment (Electrophoresis Element and Production Method)

2. Second Embodiment (Electrophoresis Element and Production Method)

3. Third Embodiment (Electrophoresis Element and Production Method)

4. Fourth Embodiment (Electrophoresis Element and Production Method)

5. Fifth Embodiment (Electrophoresis Element and Production Method)

6. Sixth Embodiment (Display Apparatus and Electronic Device)

### 1. First Embodiment

### Electrophoresis Element

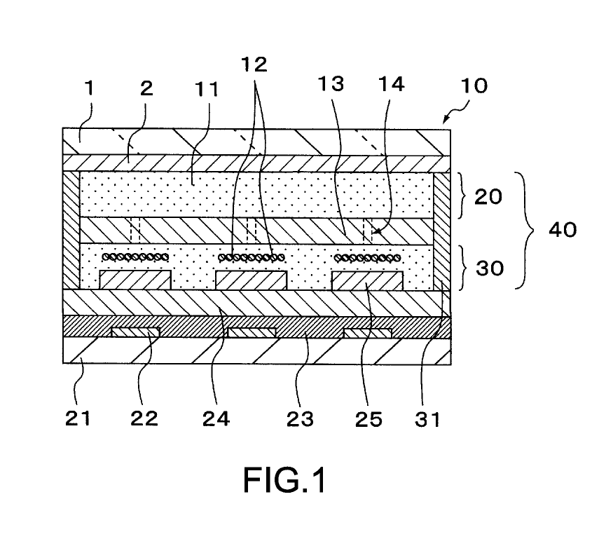

FIG. 1 is a sectional view showing an electrophoresis element 10 according to a first embodiment.

As shown in FIG. 1, the electrophoresis element 10 includes insulation liquid layers 11 between a first base material, i.e., a transparent base material 1 and a second base material, i.e., a base material 21. On an entire surface of the transparent base material 1 at a side of the insulation liquid layer 11, a counter electrode, i.e., a graphene electrode 2 is disposed. The transparent base material 1 is in contact with the insulation liquid layer 11 via the graphene electrode 2. Also, on a surface of the base material 21 at a side facing to the graphene electrode 2, at least one TFT 22 is disposed at a distance from other TFTs 22. A protection layer 23 is disposed on an entire surface of the base material 21 to cover the TFTs 22. On the protection layer 23, a planarizing insulation layer 24 is laminated. On the planarizing insulation layer 24, at least one pixel electrode 25 is disposed at a distance from other pixel electrodes 25 facing to the TFTs 22. The base material 21 is disposed to be in contact with the insulation liquid layer 11 at a side of the planarizing insulation layer 24 and the pixel electrodes 25. Accordingly, the graphene electrode 2 is disposed facing to the pixel electrodes 25 via the insulation liquid layers 11. In the insulation liquid layers 11, a porous layer 13 is disposed facing to the graphene electrode 2 and the pixel electrodes 25 in a predetermined distance. The insulation liquid layers 11 are in contact with both main surfaces of the porous layer 13. In other words, the insulation liquid layers 11 are separated by the porous layer 13 into a first insulation liquid layer, i.e., a display section 20, and a second insulation liquid layer, i.e., a shelter section 30. A surface of the porous layer 13 facing to the transparent base material 1 is in contact with the display section 20, and an opposite surface of the porous layer 13 facing to the base material 21 is in contact with the shelter section 30. Perimeters of the transparent base material 1 and the base material 21 are sealed with sealing bodies 31. An area ranging from the display section 20 to the shelter section 30 will be an electrophoresis section 40. The porous layer 13 has at least one through hole 14 configured such that the display section 20 can be communicated with the shelter section 30. The through hole 14 is configured such that electrophoresis particles 12 can pass through between the display section 20 and the shelter section 30. The electrophoresis particles 12 are dispersed in the insulation liquid layers 11, and migrate through the electrophoresis section 40 via the through holes 14, thereby displaying images on the display section 20.

The transparent base material 1 is not especially limited as long as it has a material and a shape that easily transmit light. In particular, a material having a high transmittance of visible light is desirably used for the transparent base material 1. Also, a desirable material has shielding properties for blocking penetration of water or gas from outside of the electrophoresis element, and has excellent solvent resistance and weatherability. Specific examples of the material used in the transparent base material 1 include transparent inorganic materials such as quartz and glass, and transparent plastics including polyethylene terephthalate, polyethylene naphthalate, polycarbonate, polystyrene, polyethylene, polypropylene, polyphenylene sulfide, vinylidene polyfluoride, acetyl cellulose, brominated phenoxy, aramides, polyimides, polystylenes, polyarylates, polysulfones and polyorefines. More specifically, a substrate or a film composed of these materials is desirable. Desirably, the transparent base material 1 has a reflectance of 1.3 to 1.6. In addition, a thickness of the transparent base material 1 is not especially limited, and can be selected based on the light transmittance or the property of shielding inside and outside of the electrophoresis element, as appropriate.

The base material 21 is basically not limited as long as the element can be formed on the surface, and can be composed of materials known in the related art selected as appropriate. The base material 21 may be transparent or opaque. In addition to those described above for the transparent base material 1, a substrate or a film composed of a metal material, an inorganic material or a plastic material can be used. Examples of the metal material include aluminum (Al), nickel (Ni) or stainless steel. Examples of the inorganic materials include a variety of ceramics. Examples of the plastic material include a variety of plastics, e.g., phenol-based, epoxy-based, ionomer-based plastics, polyvinyl chloride and nylon.

The graphene electrode 2 is basically not limited as long as there is at least one graphene layer. Specifically, one to 10 graphene layers are desirable. Also, the graphene electrode 2 is desirably composed of a doped graphene film. The graphene film of the graphene electrode 2 is doped by adsorbing acceptor particles. Examples of the acceptor particles include an acid such as gold chloride, nitric acid, hydrochloric acid, thionyl chloride and TFSA, a metal chloride such as TiCl₄, FeCl₃, NiCl₂, and TiO₂. Among them, a transparent one is desirable, but it is not limited thereto.

The insulation liquid layers 11 are basically not limited as long as the layers are composed of liquid having electrical insulation properties. The configurations of the insulation liquid layers as described above can be selected as appropriate. Desirably, the insulation liquid layers 11 have a reflectance of 1.3 to 1.6.

The configuration of the electrophoresis particles 12 is basically not limited. For example, in order to provide a contrast depending on the role played by the electrophoresis particles 12, configurations known in the related art may be combined as appropriate. The material of the electrophoresis particles 12 is basically not limited, is selected as described above, and can be selected from those described above as the electrophoresis particles as appropriate. Among them, examples of organic pigments include an azo-based pigment, a metal complex azo-based pigment, a poly-condensed azo pigment, a flavanthrone-based pigment, a benzimidazolone-based pigment, a phthalocyanine-based pigment, a quinacridone-based pigment, an anthraquinone-based pigment, a perylene-based pigment, a perinone-based pigment, an anthrapyridine-based pigment, a pyranthrone-based pigment, a dioxadine-based pigment, a thioindigo-based pigment, an isoindolinone-based pigment, a quinophthalone-based pigment and an indanthrene-based pigment. Examples of inorganic pigments include zinc oxide, antimony white, carbon black, iron black, titanium boride, red iron oxide, Mapico yellow, red lead, cadmium yellow, zinc sulfide, lithopone, barium sulfide, cadmium selenide, calcium carbonate, barium sulfate, lead chromate, barium carbonate, white lead and alumina white. Examples of dyes include a nigrosine-based dye, an azo-based dye, a phthalocyanine-based dye, a quinophthalone-based dye, an anthraquinone-based dye and a methane-based dye. Examples of carbon materials include carbon black. Examples of metal materials include gold, silver and copper. Examples of metal oxides include titanium oxide, zinc oxide, zirconium oxide, barium titanate, potassium titanate, copper chrome oxide, copper manganese oxide, copper iron manganese oxide, copper chrome manganese oxide and copper iron chrome oxide. Examples of polymer materials include a polymer compound having a functional group that absorbs visible light. The polymer compound is not especially limited as long as it absorbs visible light.

The content of the electrophoresis particles 12 in the insulation liquid layers 11 is not especially limited, but is desirably 0.1% by weight to 10% by weight. This is because shielding properties and migrating properties of the electrophoresis particles 12 are ensured. Specifically, if the content is less than 0.1% by weight, it may be difficult to shield (cover) the porous layer 13 by the electrophoresis particles 12. On the other hand, if the content exceeds 10% by weight, dispersibility of the electrophoresis particles 12 may be decreased. This makes the electrophoresis particles 12 less migrate, in some cases, aggregate.

Desirably, the electrophoresis particles 12 have some light reflection properties (light reflectance). The light reflectance of the electrophoresis particles 12 is not especially limited, but is desirably such that at least the electrophoresis particles 12 can shield the porous layer 13. This is because a contrast is provided by a difference between the light reflectance of the electrophoresis particles 12 and the light reflectance of the porous layer 13. For example, when the porous layer 13 displays a white color and the electrophoresis particles 12 display a black color, the reflectance of the electrophoresis particles 12 is desirably as small as possible.

The porous layer 13 is basically not limited as long as it is composed of a porous material having at least one through hole 14. For example, it is desirably a three-dimensional structure formed of the fibrous structures. The fibrous structures may be entangled randomly. A plurality of the fibrous structures may be gathered and overlapped randomly. Both may be mixed. In this way, when the porous layer 13 is composed of the fibrous structures, the light incident on the surface of the porous layer 13 at the display section 20 side is multiple scattered, thereby improving the light reflectance at the surface. As the light reflectance is improved, the porous layer 13 can be formed thin. In addition, by supporting the non-migrating particles on the fibrous structures of the porous layer 13, the reflectance of the porous layer 13 is further improved and the contrast at the display section 20 is improved. As the materials of the fibrous structures, the above-described materials can be selected as appropriate. Examples of the polymer materials include nylon, polylactic acid, polyamide, polyimide, polyethylene terephthalate, polyacrylonitrile, polyethylene oxide, polyvinylcarbazole, polyvinyl chloride, polyurethane, polystyrene, polyvinyl alcohol, polysulfone, polyvinylpyrrolidone, polyvinylidene fluoride, polyhexafluoropropylene, cellulose acetate, collagen, gelatin, chitosan and copolymers thereof. Examples of the inorganic materials include titanium oxide. An average fiber diameter of the fibrous structures is basically not limited as long as the fiber has a size to support the non-migrating particles, but is desirably as small as possible. Specifically, the average fiber diameter of the fibrous structures is desirably 0.1 μm to 10 μm, more desirably 1 μm to 10 μm. An average diameter of the porous layer 13 is basically not limited, but is desirably as large as possible. Specifically, the average diameter is desirably 0.1 μm to 10 μm. A thickness of the porous layer 13 is basically not limited, but is desirably 5 μm to 100 μm.

The pixel electrodes 25 are basically not limited as long as the electrophoresis particles 12 can migrate the porous layer 13 by generating the electric field between the pixel electrodes 25 and the graphene electrode 2, and can be selected from the configurations known in the related art as appropriate. Desirably, the pixel electrodes 25 are configured such that the electrophoresis particles 12 can migrate through the porous layer 13 from the surface being in contact with the shelter section 30 to the surface being in contact with the display section 20 by generating the electric field. The TFTs 22 for controlling the pixel electrodes 25, the protection layer 23 and the planarizing insulation layer 24 can be selected from the configurations known in the related art as appropriate.

The sealing body 31 may have basically any configuration, but desirably has a configuration that prevents the insulation liquid of the insulation liquid layers 11 from leaking outside, insulation substance in the insulation liquid layers 11 from drying and contaminants from entering into the insulation liquid layers 11. The material of the sealing body 31 desirably has light resistance, insulating properties and moisture proof. The sealing body 31 may be transparent or opaque. The thickness of the sealing body 31 is basically not limited, but desirably 10 μm to 100 μm, for example.

[Production Method of Electrophoresis Element]

A method of producing the electrophoresis element will be described.

Firstly, a graphene film is formed on a transparent base material 1 by a method known in the related art. Desirably, the graphene film is formed on the transparent base material 1 by growing graphene on a catalyst base material using thermal CVD method and by transferring grown graphene to the transparent base material 1. In this way, the graphene film is formed on the transparent base material 1. Next, on a main surface of the formed graphene film, a dopant is applied and dried, thereby providing a doped graphene film, i.e., a graphene electrode 2.

The TFTs 22, a protection film 23, the planarizing insulation layer 24 and the pixel electrodes 25 laminated on the base material 21 in this order can be produced by selecting the methods known in the related art as appropriate. Also, the porous layer 13 can be produced by selecting the methods known in the related art as appropriate. For example, when the porous layer 13 has the fibrous structures including the non-migrating particles, the porous layer 13 can be produced as follows: Firstly, a resin material that is a raw material of the fibrous structures is added and mixed into a solvent to prepare a first solution. Next, titanium oxide, i.e., the non-migrating particles, is added and mixed into the first solution to prepare a spinning solution. Next, the spinning solution is entered into syringe. The base material 21 on which the pixel electrodes 25 are formed is spun and then dried, thereby providing the fibrous structures including the non-migrating particles. The electrophoresis particles 12 can be produced by the method known in the related art, and can be provided by coating carbon black with a resin polymer, for example. Next, the resultant electrophoresis particles 12 are mixed with the insulation liquid and are agitated to prepare the insulation liquid where the electrophoresis particles 12 are dispersed.

Then, after the resin films are placed at peripherals of the graphene electrode 2 as the sealing bodies 31, the base material 21 is overlaid such that the graphene electrode 2 faces the porous layer 13. Finally, the insulation liquid containing the electrophoresis particles 12 is injected into a space between the graphene electrode 2 and the base material 21 from a liquid inlet (not shown) formed in advance at the sealing body 31 to form the insulation liquid layers 11. Thereafter, the liquid inlet is closed. In this way, the intended electrophoresis element 10 is produced.

[Action of Electrophoresis Element]

The action of the electrophoresis element 10 will be described.

When a voltage is applied to the electrophoresis element 10, the electrophoresis particles 12 migrate through the electrophoresis section 40 to provide a contrast, whereby the electrophoresis element 10 functions as an image display element. An operational principle is as follows: In this case, the porous layer 13 displays a white color (a light display) and the electrophoresis particles 12 display a black color (a dark display).

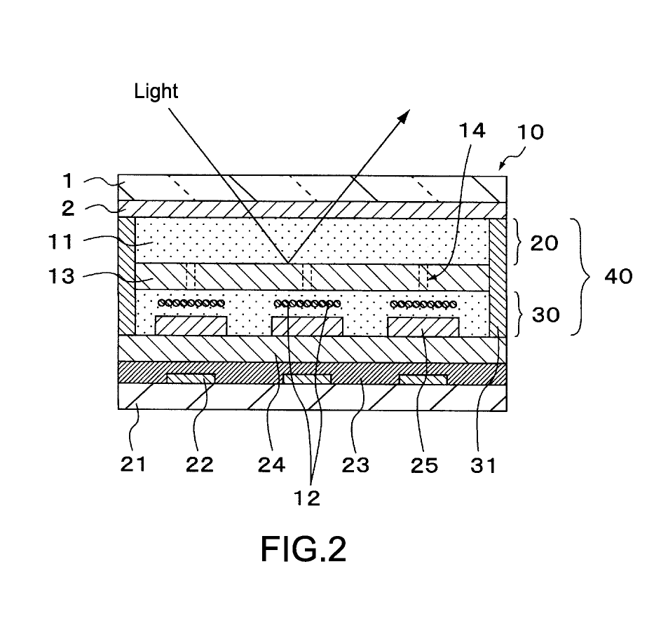

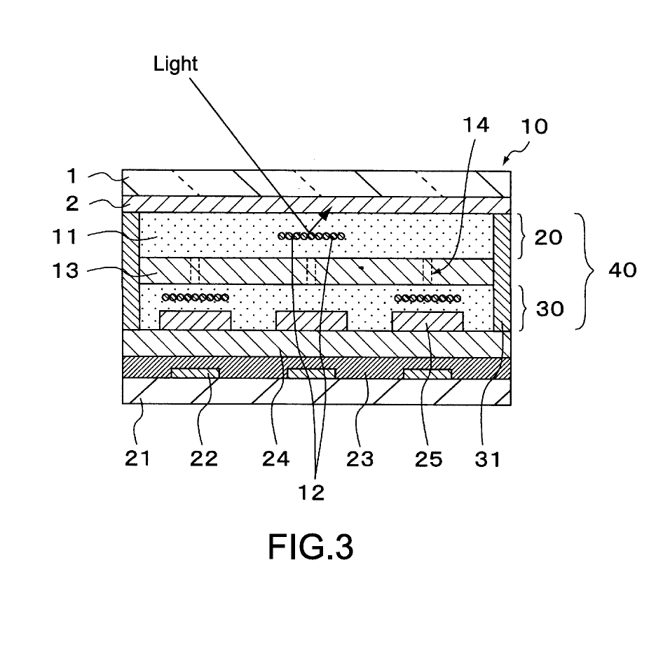

FIG. 2 shows an initial state of the electrophoresis element 10 and FIG. 3 shows a driving state of the electrophoresis element 10.

As shown in FIG. 2, in the initial state of the electrophoresis element 10 where no voltage is applied between the pixel electrodes 25 and the graphene electrode 2, all the electrophoresis particles 12 within the pixels are positioned at the shelter section 30. As the electrophoresis particles 12 positioned at the shelter section 30 are fully blocked by the porous layer 13, the display section 20 in the pixels will display white. In other words, the visible light incident on the transparent base material 1 from outside and reached the porous layer 13 via the graphene electrode 2 is mostly scattered or reflected on the porous layer 13. The reflected visible light is again transmitted through the graphene electrode 2 and the transparent base material 1, is released outside and enters into human's eyes. The human perceives the light as white. For example, when all the pixels are in the initial state, the whole display section 20 displays a white color, i.e., no images.

On the other hand, as shown in FIG. 3, when a voltage is applied between the pixel electrodes 25 and the graphene electrode 2, the all electrophoresis particles 12 within the shelter section 30 migrate to the display section 20 through the through holes 14, and the display section 20 in the pixels will display black. In other words, the visible light incident on the transparent base material 1 from outside and reached the display section 20 via the graphene electrode 2 is mostly absorbed by the electrophoresis particles 12 before reaching the porous layer 13. The reflected light released outside becomes very narrow, and the human perceives the light as black. In this case, when any pixels where the voltage is applied between the pixel electrodes 25 and the graphene electrode 2 are selected by the TFTs 22, some pixels display white and some pixels display black and, a contrast is therefore provided, i.e., images are displayed in the display section 20.

As described above, according to the first embodiment, as the counter electrode of the electrophoresis element 10, the graphene electrode 2 having high visible light transmittance relative to a sheet resistance as compared to the ITO electrode is used. Without sacrifice of the conductivity of the counter electrode, the visible light transmittance can be improved. In this way, without sacrifice of responsibility of the electrophoresis element 10, losses of the visible light incident on the display section 20 and the light reflected from the display section 20 in the counter electrode can be reduced as compared to the related art. Thus, as the losses of the visible light in the counter electrode are decreased, a larger amount of the light reflected from the display section 20 can be released from the transparent substrate 1. As compared to the related art, the electrophoresis element 10 having a higher contrast can be provided.

The configuration of the electrophoresis section 40 is not limited to this embodiment. Any configurations of the electrophoresis sections in the known electrophoresis elements can be selected as appropriate. For example, the electrophoresis section 40 may have a configuration that no porous layer 13 is provided.

### 2. Second Embodiment

### Electrophoresis Element

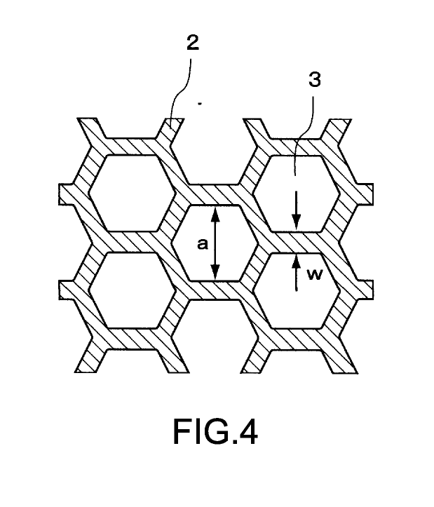

FIG. 4 is a plan view showing an example of the graphene electrode 2 of the electrophoresis element 10 according to a second embodiment. As shown in FIG. 4, the graphene electrode 2 has a plurality of openings 3 each having a regular hexagon shape. The openings 3 having the similar configurations are arranged regularly in predetermined intervals, thereby providing a hexagon grid (honeycomb) network as a whole.

The openings 3 are provided by removing the graphene electrode 2 formed on the transparent base material 1. The surfaces of the openings 3 are composed of the transparent base material 1. As long as at least one opening 3 is formed in the graphene electrode 2, its position, size etc. is not limited. An aperture ratio of the graphene electrode 2 is desirably 25% to 75%, more desirably 25% to 50%. The openings 3 may have basically any shapes, and may be n-sided polygons (n=>3) including triangle, square and rectangle other than the above-described regular hexagon; circle; oval and the like. As the n-sided polygons (n=>3), regular n-sided polygons are desirable. Desirably, a plurality of the openings 3 have the same size. An arrangement of the openings 3 is basically not limited, but may desirably be at equal intervals. Examples of the arrangement include a triangle grid arrangement, a cross grid arrangement and a punch hole arrangement other than the above-described hexagon grid. When a plurality of the openings 3 have the hexagon grid arrangement, an interval “a” between two sides faced in the hexagonal openings 3 is desirably 8 μm to 120 μm, more desirably 8 μm to 52 μm, most desirably 8 μm to 20 μm. When the openings are the n-sided polygons (n=>3) and n has an even number, the interval can be the distance between two sides faced. When the openings are the n-sided polygons (n=>3) and n has an odd number, the interval can be the distance between a peak and a side faced. A width “w” of the graphene electrode 2 sandwiched between the openings 3 adjacent is desirably 2 μm to 32 μm, more desirably 4 μm to 16 μm, most desirably 4 μm to 8 μm. Others are similar to those of the electrophoresis element 10 according to the first embodiment.

[Production Method of Electrophoresis Element]

In the method of producing the electrophoresis element 10, the graphene film is firstly formed on the transparent base material 1, the openings are then formed in the formed graphene film, and the dopant is applied to and dried on the formed openings, thereby providing the graphene electrode 2 having the openings 3. The openings are formed by the known etching method, for example. Desirably, the graphene film is selectively removed by oxygen reactive ion etching (RIE), for example. Doping may be carried out before the openings are formed in the graphene thin film. Then, the openings 3 may be formed as described above. Alternatively, after the openings 3 are formed in the graphene thin film as described above, the doping may be carried out. In light of an effect of the formation of the openings on the dopant, the doping is desirably carried out after the openings 3 are formed. Others are similar to those of the method of producing the electrophoresis element 10 according to the first embodiment. In this way, the intended electrophoresis element 10 is produced.

[Action of Electrophoresis Element]

The action of the electrophoresis element 10 is similar to the action of the electrophoresis element 10 according to the first embodiment.

According to the second embodiment, as at least one opening 3 is formed in the graphene electrode 2 of the electrophoresis element 10 according to the first embodiment, the visible light transmittance of the counter electrode can be further improved in addition to the similar advantages provided by the electrophoresis element 10 in the first embodiment.

### 3. Third Embodiment

### Electrophoresis Element

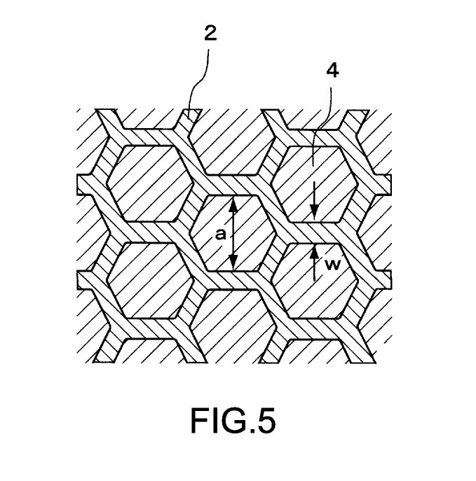

FIG. 5 is a plan view showing an example of the graphene electrode 2 of the electrophoresis element according to a third embodiment. As shown in FIG. 5, the graphene electrode 2 further has a transparent layer 4 disposed to selectively fill the openings 3 configured similar to the electrophoresis element according to the second embodiment.

The transparent layer 4 is disposed in order to prevent the dopant used in the doping step from adhering to the openings 3 showing in the second embodiment. As long as the transparent layer 4 is disposed to fill at least a part of the openings 3, it is basically not limited. Desirably, the transparent layer 4 is disposed to fill entire surfaces of the openings 3. In addition, the transparent layer 4 desirably has the same thickness as the graphene electrode 2. The material of the transparent layer 4 can be selected from the materials described above as the transparent material as appropriate, but desirably is a hydrophilic transparent resin among others. More desirably, the resin has high visible light transmittance. Furthermore, the resin desirably has high resistance to the dopant and the dopant solution for the graphene film. Others are similar to those of the second embodiment.

[Production Method of Electrophoresis Element]

In the method of the electrophoresis element 10, after the graphene film having the openings 3 is formed similar to the second embodiment, a hydrophilic resin is applied over an entire surface of the graphene film having the openings 3. The hydrophilic resin can be applied if a hydrophilic agent is used. In this case, when the transparent base material 1 having a contact angle to water smaller than that of graphene is selected, a hydrophilic resin film is formed only on the surface of the transparent base material 1 by surface tension. By drying the resin film, the transparent layer 4 can be formed. Specific examples of the transparent material having the contact angle in respect to water smaller than that of graphene include an inorganic material such as glass. Others are similar to those of the method of producing the electrophoresis element 10 according to the second embodiment. In this way, the intended electrophoresis element 10 is produced.

[Action of Electrophoresis Element]

The action of the electrophoresis element 10 is similar to the action of the intended electrophoresis element 10 according to the first embodiment.

According to the third embodiment, as the openings 3 are formed in the graphene electrode 2 similar to the second embodiment and the transparent layer 4 is disposed on the transparent base material 1 to selectively fill the openings 3, while providing the similar advantages provided by the second embodiment, adhesion of the dopant to the openings 3 upon doping is prevented when the graphene electrode 2 is formed.

### 4. Fourth Embodiment

### Electrophoresis Element

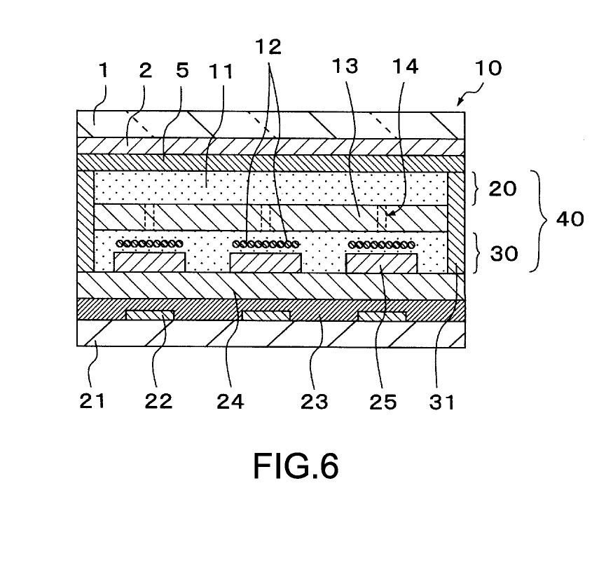

FIG. 6 is a sectional view showing the electrophoresis element 10 according to a fourth embodiment. As shown in FIG. 6, in the electrophoresis element 10, an antireflection layer 5 is laminated on the surface of the graphene electrode 2.

As long as the antireflection layer 5 is formed in order to prevent the visible light from reflecting at an interface of the graphene electrode 2, the antireflection layer 5 is basically not limited. Desirably, the antireflection layer 5 has a function to inhibit any interaction between the electrophoresis particles 12 and the graphene electrode 2. Also, as long as the antireflection layer 5 is disposed on at least a part of the graphene electrode 2, a coverage of the antireflection layer 5 is not basically limited. Desirably, the antireflection layer 5 is formed over an entire surface of a main surface of the graphene electrode 2. Desirably, the antireflection layer 5 has a refractive index of 1 or more which is smaller than that of the transparent base material 1. Specifically, the refractive index of the visible light is desirably 1 to 1.4. In addition, the antireflection layer 5 may be a laminated structure of a material having a high refractive index and a material having a low refractive index. In order to dispose the display unit 20 and the graphene electrode 2 as close as possible, a thickness of the antireflection layer 5 may be as thin as possible. Specific thickness of the antireflection layer 5 is desirably 0.01 μm to 0.1 μm. When the graphene electrode 2 has the openings 3, the antireflection layer 5 can be formed on the surface of the graphene electrode 2 as described above. In this case, the antireflection layer 5 is desirably formed across the surface of the graphene electrode 2 and the surfaces of the openings 3, more desirably formed over the entire surfaces thereof.

The material of the antireflection layer 5 is basically not limited as long as an insulation material having visible light transmission that is capable of forming a film on the surface of the graphene film. Desirably, the material of the antireflection layer 5 can successfully form a film on the surface of the graphene film. An example of such a material is a resin material that can be coated thereon. Specifically, a thermoplastic resin material that is dissolved in a solvent and is coated and dried to form a film is desirable. Also, a thermosetting resin material that can be coated and then cured by heat or light, a light curing resin material or other chemically reactive resin material are desirable. Examples of these resin materials include a polycarbonate resin, a PES resin, a silicon-based resin, an acrylic-based resin, an epoxy-based resin, urethane acrylate, a vinyl-based resin, a melamine-based resin, a polyester-based resin, oxetane, a butadiene-based resin, a polyethylene-based resin, polyimide and allyl-based resin. Desirably, the material of the antireflection layer 5 has a low refractive index, in particular, a low refractive index for visible light. The material having a low refractive index for visible light is fluororesin including acrylic-based fluororesin, epoxy-based fluororesin, polyester-based fluororesin and polyvinyl-based fluororesin. Specific examples of fluororesin include Nafion (a trade name manufactured by E. I. du Pont de Nemours and Company), polychlorotrifluoroethylene (PCTFE), polytetrafluoroethylene (PTFE), tetrafluoroethylene (TFE), and fluorinated ethylene-propylene copolymer (FEP). Other examples include vinyl acetate resin and white carbon. Among the above-described resin, the material of the antireflection layer 5 desirably has a small refractive index difference between the material and graphene. The antireflection layer 5 may be configured of a protection film for the graphene electrode 2. In this case, the material of the antireflection layer 5 can be configured of an inorganic material instead of the above-described materials. Examples of the inorganic materials include SiO₂, HfO₂, ZrO₂, Al₂O₃, TiO₂ and the like.

In this way, as the antireflection layer 5 is disposed on the surface of the graphene electrode 2, reflection of the visible light generated on the surface of the graphene electrode 2 at a side of the insulation liquid layer 11 can be decreased. The antireflection layer 5 can function as the protection film for the graphene electrode 2. The antireflection layer 5 prevents the graphene electrode 2 from being in directly contact with the electrophoresis particles 12, thereby preventing the electrophoresis particles 12 from being aggregating on the graphene electrode 2. Others are similar to any of the first to third embodiments.

[Production Method of Electrophoresis Element]

In the method of producing electrophoresis element 10, after the graphene electrode 2 is formed on a main surface of the transparent base material 1, the openings 3 are formed by any method. Next, the intended electrophoresis element 10 is produced similar to the method of producing the electrophoresis element 10 according to the first or second embodiment except that the resin etc. is applied to the main surface of the graphene electrode 2 and then is dried to form the antireflection layer 5.

[Action of Electrophoresis Element]

The action of the electrophoresis element 10 according to the fourth embodiment is similar to the action of the electrophoresis element 10 according to the first embodiment.

According to the fourth embodiment, as the antireflection layer 5 is disposed on at least a part of the surface of the graphene electrode 2 of the electrophoresis element 10 according to any of the first to third embodiments, while the advantages similar to the first to third embodiments are provided, the visible light reflection generated on the surface of the graphene electrode at a side of the insulation liquid layer 11 can be decreased. In addition, the antireflection layer 5 also functions as the protection film for the graphene electrode 2. The antireflection layer 5 prevents the graphene electrode 2 from being in directly contact with the electrophoresis particles 12, thereby preventing the electrophoresis particles 12 from being aggregating on the graphene electrode 2.

### 5. Fifth Embodiment

### Electrophoresis Element

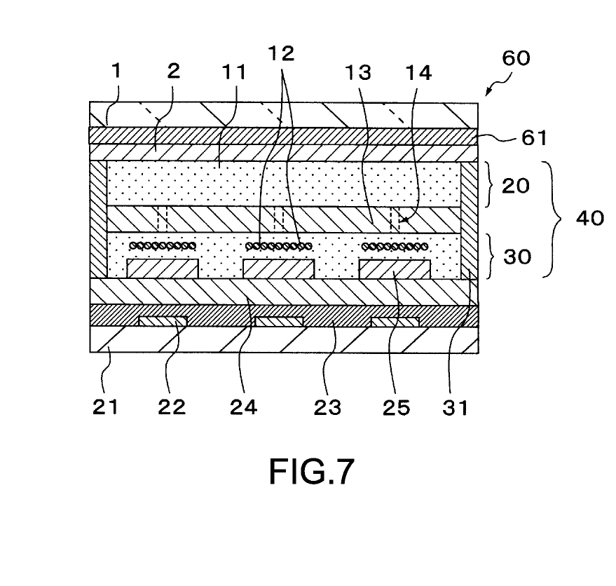

FIG. 7 is a sectional view showing an electrophoresis element 60 according to a fifth embodiment. As shown in FIG. 7, the electrophoresis element 60 includes a color filter 61 between the graphene electrode 2 and the transparent base material 1 in addition to the electrophoresis element 10 according to any of the first to fourth embodiments. According to the fifth embodiment, when the electrophoresis element 60 is colorized, disparities are not easily generated on the colorized electrophoresis element 60, as compared to the case that the color filter is disposed on the light incident surface of the transparent base material 1, as the color filter 61 is disposed between the transparent base material 1 and the graphene electrode 2. Others are similar to those of any of the first to fourth embodiments.

[Production Method of Electrophoresis Element]

The color filter 61 is formed on the entire main surface of the transparent base material 1, or the transparent base material 1 having the color filter 61 formed on the entire main surface thereof is prepared. On an entire main surface of the color filter 61, the graphene electrode 2 is formed. In this case, when the ITO film that is used as the counter electrode in the related art is formed by sputtering on the color filter 61, pigments contained in the color filter 61 are inevitably damaged. In contrast, as described above, the graphene electrode 2 is formed by transferring the graphene film formed on the catalyst base material, for example. In this way, when the graphene electrode 2 is used as the counter electrode, it is possible to form the counter electrode on the color filter 61 without damaging the color filter 61. Others are similar to those of the method of producing the electrophoresis element 10 according to any of the first to fourth embodiments. In this way, the intended electrophoresis element 20 is produced.

According to the production method according to the fifth embodiment, as the graphene electrode 2 is used as the counter electrode, it is possible to form the counter electrode on the color filter 61 without damaging the color filter 61.

[Action of Electrophoresis Element]

The action of an electrophoresis element 20 is similar to the action of the electrophoresis element 10 according to the first embodiment except that reflected light on the display section 20 is transmitted through the color filter 61 and is released outside, whereby color images are displayed.

According to the fifth embodiment, as the color filter 61 is disposed between the transparent base material 1 and the graphene electrode 2 of the electrophoresis element 10 according to any of the first to fourth embodiments, when the electrophoresis element is colorized, disparities are not easily generated. Also, when the color filter 61 is formed on the graphene electrode 2, the color filter 61 is not damaged, thereby providing the electrophoresis element 60 being capable of displaying the color images having the similar properties as the electrophoresis element 10 displaying black and white images.

### 6. Sixth Embodiment

### Display Apparatus

In a sixth embodiment, an example of application of the electrophoresis elements 10, 60 illustrated in the first to fifth embodiments will be described. The electrophoresis elements 10, 60 in the embodiments can be applied to a display apparatus by further adding a driving circuit and the like. The display apparatus can be applied to a display apparatus of an electronic device in any and all fields that displays video signals externally input or video signals internally produced from a television apparatus, a digital camera, a notebook-size personal computer, a mobile terminal apparatus such as a mobile phone or a video camera as picture images or video images. The configurations of the electronic device as described below are just examples and can be changed as appropriate.

[Electronic Device]

The display apparatus of the present application can be applicable to the electronic device for many purposes. Types of the electronic device are not especially limited. The display apparatus can be mounted on the following electronic devices, for example.

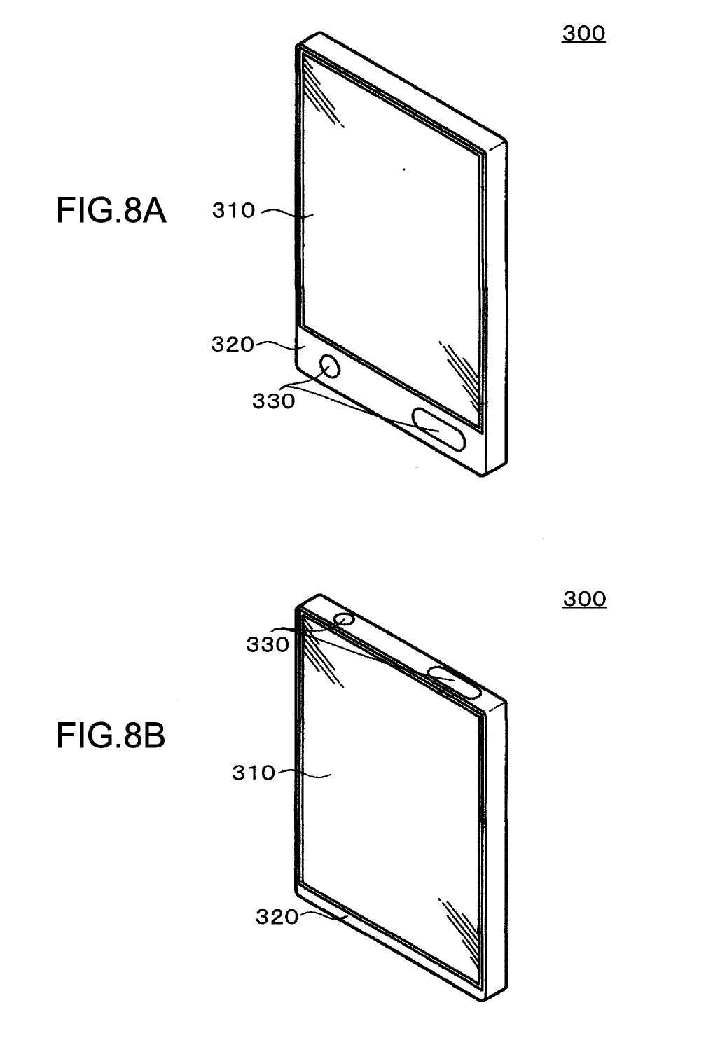

FIGS. 8A and 8B each shows an exterior appearance of an electronic book 300. The electronic book 300 has a display section 310, a non-display section 320, and an operation section 330, for example. The operation section 330 may be disposed at a front face of the non-display section 320 as shown in FIG. 8A, or may be disposed at an upper face as shown in FIG. 8B. The display apparatus may be mounted on a PDA having a configuration similar to that of the electronic book 300 shown in FIGS. 8A and 8B.

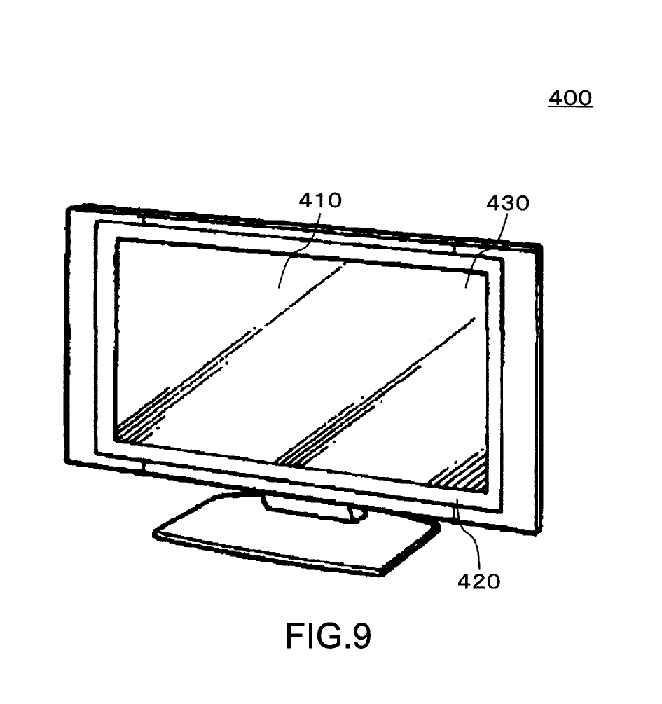

FIG. 9 shows an exterior appearance of a television apparatus 400. The television apparatus 400 has a video image display screen 420 including a front panel 410 and a filter glass 430.

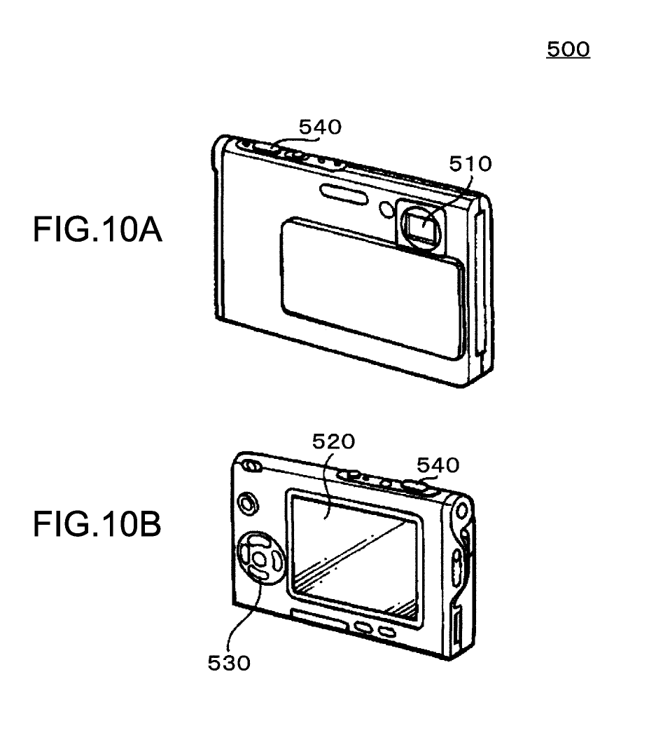

FIGS. 10A and 10B each shows an exterior appearance of a digital still camera 500. FIG. 10A shows a front face, and FIG. 10B shows a rear face. The digital still camera 500 has a light emitting section 510 for flashing, a display section 520, a menu switch 530 and a shutter button 540, for example.

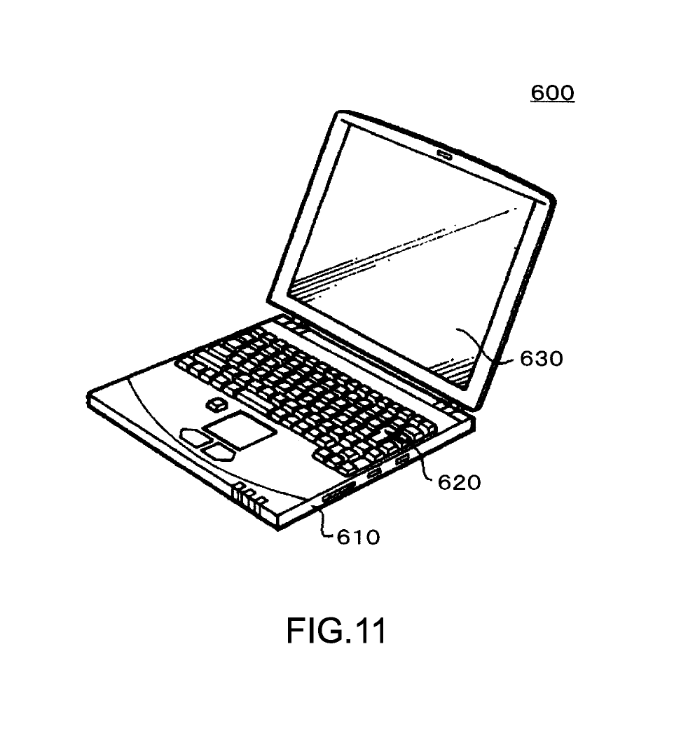

FIG. 11 shows an exterior appearance of a notebook-size personal computer 600. The notebook-size personal computer 600 has a main body 610, a keyboard 620 for character input operation, and a display section 630 for displaying images, for example.

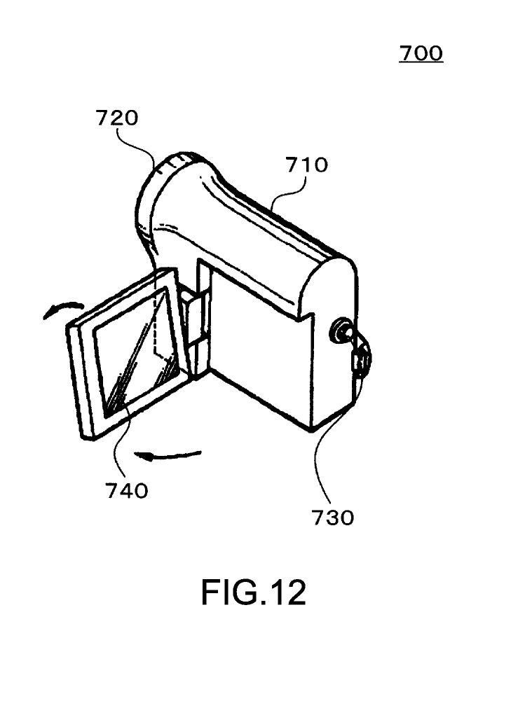

FIG. 12 shows an exterior appearance of a video camera 700. The video camera 700 has a main body 710, a lens 720 for shooting an object disposed at a front face of the main body 710, a start/stop switch 730 for image capturing, and a display unit 740, for example.

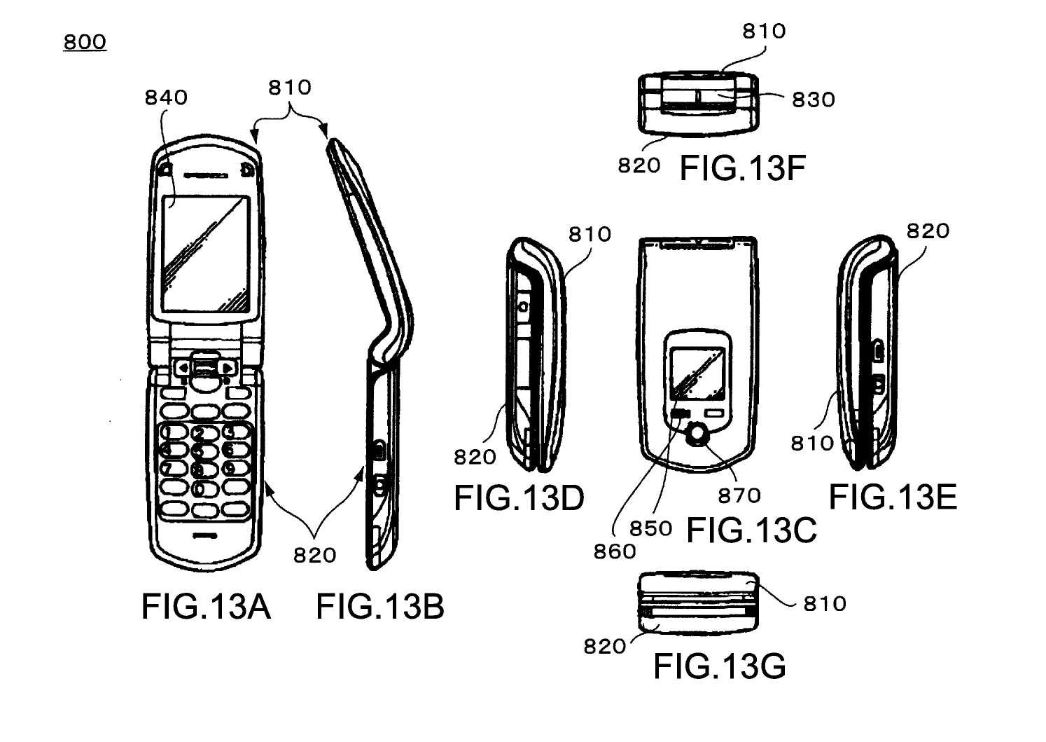

FIGS. 13A to 13G each shows an exterior appearance of a mobile phone 800. FIG. 13A shows a front face of the mobile phone 800 opened. FIG. 13B shows a side face of the mobile phone 800 opened. FIG. 13C is a front face of the mobile phone 800 closed. FIG. 13D is a left side face of the mobile phone 800 closed. FIG. 13E is a right side face of the mobile phone 800 closed. FIG. 13F is an upper face of the mobile phone 800 closed. FIG. 13G is a lower face of the mobile phone 800 closed. In the mobile phone 800, an upper housing 810 is connected to a lower housing 820 via a connection unit (a hinge unit) 830, for example. The mobile phone 800 has a display 840, a sub-display 850, a picture light 860 and a camera 870.

### Example 1

### Example Corresponding to the First Embodiment

Firstly, a glass substrate on which a graphene electrode was formed was produced by the following method.

Graphene was synthesized on a catalyst substrate by a thermal CVD method. Synthesis of graphene was carried out as follows: A Cu foil was used as the catalyst substrate. Graphene was grown at a temperature of 960° C. for 10 minutes under an atmosphere of methane:hydrogen=100 cc:5 cc. Next, the glass substrate was prepared. The synthesized graphene was transferred to the glass substrate. Transferring to the glass substrate was carried out as follows: a 4% polymethacrylate methyl resin (PMMA) solution was applied to the Cu foil on which a graphene thin film was grown by spin coating at 2000 rpm for 40 seconds. Thereafter, the Cu foil was baked at 130° C. for 5 minutes. Using a 1M iron nitrate solution, Cu was etched. After etching, the glass substrate was cleaned with ultrapure water to transfer graphene on entire surface thereof, and was naturally dried. Thereafter, the glass substrate was annealed at 400° C. under hydrogen atmosphere to remove PMMA. In this way, the glass substrate where the graphene thins film was formed on the entire surface thereof was provided.

Next, the graphene thin film on the glass substrate obtained was doped as follows: Gold chloride (AuCl₃) was dissolved into nitromethane to provide a 10 mM solution. The solution was applied to a side where the graphene film was formed on the glass substrate by spin coating at 2000 rpm for 40 seconds. Thereafter, the glass substrate was dried under vacuum. In this way, gold chloride being acceptor molecules was adsorbed to the graphene thin film. Thus, the glass substrate on which the graphene electrode that was the doped graphene thin film was formed on the surface thereof was provided. The resultant thickness of the graphene electrode was 0.3 nm.

Next, by the following procedures, black electrophoresis particles and a white porous layer (fibrous structures containing particles) were produced. Firstly, 10 g of carbon black (No. 40 manufacture by Mitsubishi Chemical Corporation) was added to 1 dm³ (=L) of water and was electromagnetic stirred. Then, 1 cm³ (=1 mL) of hydrochloric acid (37% by weight) and 0.2 g of 4-vinyl aniline were added to prepare a solution A. Then, 0.3 g of sodium nitrate was dissolved into 10 cm³ of water, which was heated to 40° C. to prepare a solution B. Then, the solution A was slowly added to the solution B, which was stirred for 10 hours. Then, the product obtained by the reaction was centrifuged to provide a solid. Then, the solid was rinsed with water, was centrifuged by acetone, was rinsed, and dried overnight by a vacuum dryer (50° C.).

Then, to a reaction flask equipped with a nitrogen purge apparatus, an electromagnetic stirrer and a reflux column, 5 g of the solid, 100 cm³ of toluene, 15 cm³ of 2-ethylhexyl methacrylate and 0.2 g of AIBN were added and mixed. Then, while stirring, the reaction flask was purged with nitrogen for 30 minutes. Then, the reaction flask was injected into an oil bath, was stirred continuously, was gradually heated to 80° C., and was kept for 10 hours. Then, the solid was centrifuged. The solid was centrifuged together with tetrahydrofuran (THF) and ethyl acetate. Every three times of the centrifuge, the solid was rinsed. Thereafter, the solid was taken out to dry by a vacuum dryer (50° C.) overnight. In this way, 4.7 g of polymer-coated carbon black including black electrophoresis particles were provided.

Then, as the insulation liquid, the IsoparG (manufactured by Exxon Mobil Corporation) solution containing 0.5% of N,N-dimethylpropane-1,3-diamine, 12-hydroxyoctadecanoic acid and methoxysulfonyloxymethane (Solspersel 7000 manufactured by The Lubrizol Corporation and 1.5% of sorbitan trioleate (Span85) was prepared. To 9.9 g of the insulation liquid, 0.1 g of the electrophoresis particles were added, which was agitated by a bead mill for 5 minutes. Then, the mixed liquid was centrifuged (for 5 minutes) by a centrifuge machine (2000 rpm) and then the beads were removed.

Then, a raw material of the fibrous structures, i.e., 12 g of polyacrylonitrile (PAN manufactured by Sigma-Aldrich Corporation, molecular weight=150000) was dissolved into 88 g of N,N′-dimethylformamide to prepare a solution C. Then, non-migrating particles, i.e., 40 g of titanium oxide (TITONE R-42 manufactured by Sakai Chemical Industry Co., Ltd.) was added to 60 g of the solution C, which was mixed by the bead mill to prepare a spinning solution. Then, the spinning solution was inserted into a syringe. On the glass substrate where the pixel electrode (ITO) having the predetermined pattern was formed, 8 reciprocating spinning was carried out using an electrospinning apparatus (NANON manufactured by Mec Company Ltd.) The spinning conditions were: Field Intensity=28 kV, Discharge Speed=0.5 cm³/min, Spinning Distance=15 cm, Scan Rage=20 mm/sec. Then, the glass substrate was dried in a vacuum oven (temperature=75° C.) for 12 hours to form the fibrous structures (polymer materials). In this way, as the white porous layer, the fibrous structures containing the non-migrating particles were provided.

Then, on the glass substrate where the graphene electrode was formed thereon provided by the former step as the counter electrode, PET films (thickness of 50 mm) were placed as the sealing bodies, i.e., spacers. Thereafter, the glass substrate on which the fibrous structures constituting the pixel electrodes and the porous layer were formed was overlaid thereon. Finally, the insulation liquid where the electrophoresis particles were dispersed was injected into a space between the two glass plates. In this way, the intended electrophoresis element was provided.

### Example 2

### Example Corresponding to the Second Embodiment

A glass substrate where a graphene thin film was formed on the entire surface was produced similar to the first embodiment.

Next, the openings were formed in the graphene thin film on the provided glass substrate. The openings were formed as follows: Photoresist was applied on the graphene thin film formed on the glass substrate by spin coating to form a photoresist layer. Next, the photoresist layer was selectively exposed and developed. Then, the graphene thin film was selectively removed by oxygen RIE (Reactive Ion Etching). The openings have the configuration arranged regularly in the predetermined intervals as a hexagon grid (honeycomb) shape as shown in FIG. 4. All the openings in the hexagon grids were formed such that they had the same shape and the size, and the interval “a” between the sides faced of the openings was 51.8 mm. The graphene thin film was formed such that a wide w of the side sandwiched by the adjacent openings was 8 μm. The coverage of the graphene thin film formed was 25%. Thereafter, the photoresist layer was removed, thereby providing the glass substrate where the graphene thin film having the openings was formed on the entire surface.

Next, the graphene electrode having the openings was produced and doped similar to Example 1 in the resultant graphene thin film having the openings on the glass substrate. Similar to Example 1, the intended electrophoresis element 10 was produced.

### Example 3

### Example Corresponding to the Third Embodiment

A glass substrate where a graphene thin film was formed on the entire surface was produced similar to Example 1.

Next, an antireflection layer, Nafion (a trade name manufactured by E. I. du Pont de Nemours and Company) was formed on the surface of the graphene electrode as described below.

10 wt % Nafion solution DE-1021 (a trade name manufactured by E. I. du Pont de Nemours and Company) was 5 fold diluted with isopropyl alcohol (IPA), thereby providing a 2 wt % Nafion solution. Next, the prepared Nafion solution was applied to the surface of the resultant glass substrate at a side of the doped graphene thin film formed. The application was carried out by spin coating at 3000 rpm for 60 seconds. Thereafter, the Nafion solution was dried for 10 minutes, thereby forming a Nafion (a trade name manufactured by E. I. du Pont de Nemours and Company) film covering whole of the graphene electrode. The resultant Nafion (a trade name manufactured by E. I. du Pont de Nemours and Company) film had a film thickness of 0.1 μm. Nafion (a trade name manufactured by E. I. du Pont de Nemours and Company) used was represented by the following chemical formula (1). Others were similar to Example 1, thereby providing the intended electrophoresis element.

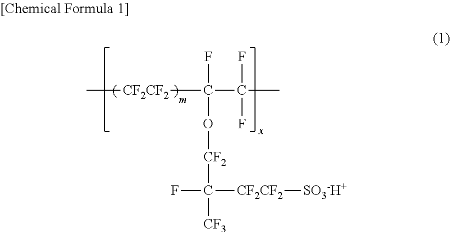

### Example 4

### Example Corresponding to the Fourth Embodiment

A glass substrate where a graphene electrode having the openings was formed on the entire surface was produced similar to Example 2. Next, the Nafion (a trade name manufactured by E. I. du Pont de Nemours and Company) film covering the entire surface of the graphene electrode having the openings was formed similar to Example 3. Others were similar to Example 1, thereby providing the intended electrophoresis element.

### Comparative Example

An ITO electrode was formed on an entire surface of a glass substrate by the method known in the related art. The resultant ITO electrode had a thickness of 0.03 μm. Others were similar to Example 1, thereby providing the intended electrophoresis element.

[Property Evaluation of Graphene Electrode]

As a preliminary evaluation before evaluating the properties of the electrophoresis element, the properties of the graphene electrodes produced in Examples 1 to 3 are evaluated.

Table 1 shows and compares light transmittances and sheet resistances of the graphene electrodes produced in Examples 1 to 3. The light transmittance is obtained by irradiating the light incident surface of the glass substrate with a green light having a wavelength of 550 nm and measuring light transmitting through the graphene electrode from the light incident surface of the glass substrate.

TABLE 1

| | Graphene structure | | | | Sheet |
|---|---|---|---|---|---|
| | | Antireflection | | Transmittance | resistance |
| | Coverage | layer | Doping | (%) | (Ω/square) |
| Ex. 2 | 25% | Absent | AuCl³/ | 88.45 | 822 |
| | | | nitromethane | | |
| Ex. 3 | 100% | Present | AuCl³/ | 89.03 | 230 |
| | | | nitromethane | | |
| Ex. 4 | 25% | Present | AuCl³/ | 90.39 | 903 |
| | | | nitromethane | | |

As shown in Table 1, the graphene electrodes having the openings in Examples 2 and 4 had significantly increased sheet resistances as compared to the graphene electrode uniformly formed in Example 3. This may be because of a difference in the coverage. On the other hand, the light transmittance of the glass substrate having the graphene film in Example 2 is lower than that in Example 4. A cause may be that gold chloride, i.e., the dopant, is adhered to the surface of the glass substrate of the openings. As gold chloride is very easily adhered to the glass surface, an excess large amount of gold chloride is adhered to the openings to deteriorate the light transmittance, when the graphene thin film is doped. This can be solved by replacing the glass substrate used as the transparent substrate with a transparent resin substrate, e.g., a polyethylene terephthalate (PET) substrate, because gold chloride is little adhered to the PET substrate. The transmittance in Example 3 is increased by 2.2% as compared to that in Example 2 and by 1.6% as compared to that in Example 4. The increase of the light transmittance in Example 3 as compared to that in Example 4 may be because the openings are disposed in the graphene film. The increase of the light transmittance in Example 3 as compared to that in Example 2 may be because the Nafion film, i.e., the antireflection layer, is disposed on the surface of the graphene electrode, thereby decreasing reflection at the interface of the graphene electrode.

Here, a theoretical value of the light transmittance will be considered. Firstly, the transmittance of the glass substrate is set to 91.5%, for example. Then, the theoretical value of the light transmittance will be 89.4% if the graphene film is formed on the glass substrate at 100% coverage. If the graphene film is formed on the glass substrate at 25% coverage, the theoretical value of the light transmittance will be 91%. Next, a theoretical value of the light transmittance will be considered when the graphene film is doped with gold chloride. When the graphene film is doped with gold chloride, a loss in the light transmittance is generated as described above. For example, when the loss in the light transmittance caused by gold chloride used as the dopant is 0.5%, the theoretical value of the light transmittance will be 88.9% if the graphene film is formed on the glass substrate at 100% coverage and the theoretical value of the light transmittance will be 89.4% if the graphene film is formed on the glass substrate at 25% coverage. These theoretical values are well matched with the above-described measured values. Next, a theoretical value of the light transmittance will be considered when the Nafion film is disposed on the graphene film. When the Nation film can decrease the reflection at the interface of the graphene electrode by 2.6%, the theoretical value of the light transmittance will be 91.5% if the graphene film is formed on the glass substrate at 100% coverage and the theoretical value of the light transmittance will be 1% if the graphene film is formed on the glass substrate at 25% coverage. Although the above-described measured values are lower than the theoretical values, the light transmittances are increased by inhibiting the reflection at the interface of the graphene electrode. The measured values are lower than the theoretical values because the transmittances may be decreased by entering impurities during manufacture.

It is thus shown that when the coverage of the graphene electrode disposed on the glass substrate is 25% and the Nafion film is disposed on the entire surface of the glass substrate at the side of the graphene electrode, the light transmittance is increased. When the glass substrate used as the transparent substrate is replaced with the transparent resin substrate such as the PET substrate, adhesion of gold chloride to the transparent substrate is avoided and the graphene electrode having a still higher light transmittance than that provided in this measurement may be provided. In addition, in order to prevent the adhesion of gold chloride to the openings, the following ways can be taken. As a first way, the whole glass substrate on which the graphene electrode having the openings is formed is treated with a silane coupling agent, for example. With this treatment, a contact angle of the openings in respect to water can be increased to inhibit the adhesion of gold chloride. As a second way, the main surface of the glass substrate may be treated with the silane coupling agent to increase the contact angle in respect to water, for example. The graphene film is formed on the main surface to form the openings and is doped with gold chloride, whereby surface energy on the surfaces of the openings is different from that in an initial state, and gold chloride is therefore hard to be adhered.

[Property Evaluation of Electrophoresis Element]

Next, the properties of the electrophoresis element are evaluated.

Table 2 shows light reflectances measured by irradiating the respective display sections of the electrophoresis elements in Example 1 and Comparative Example. The results are shown in Table 2. The light reflectances are measured at a white side (the porous layer) and a black side (the electrophoresis particles). Contrasts in the display sections are evaluated by a difference between the light reflectances at the white side and at the black side.

TABLE 2

| | Structure of counter | Reflectance (%) | |
|---|---|---|---|
| | electrode | White side | Black side |
| Ex. 1 | Graphene/glass substrate | 48.9 | 2.8 |
| Comp. Ex. | ITO/glass substrate | 53.2 | 2.0 |
| 1 | | | |

As shown in Table 2, the reflectance at the white side in Example 1 is lower than that in Comparative Example, and the reflectance at the black side in Example 1 is higher than that in Comparative Example. This results that the contrast in Example 1 is lower than that in Comparative Example. It can be concluded that the difference between the light reflectances at the white side and at the black side becomes not smaller than that the case when the ITO film is used and the loss of the reflected light due to the counter electrode is not decreased when the electrode having the graphene film just instead of the ITO film is used as the counter electrode.

Next, contrasts in the display sections of the electrophoresis elements including the graphene electrode having the openings are evaluated.

Table 3 shows light reflectances measured by irradiating the respective display sections in Example 2, Example 4 and Comparative Example with light. The results are shown in Table 3.

TABLE 3

| | Structure of counter electrode | | | | |
|---|---|---|---|---|---|
| | | | Antireflection | Reflectance (%) | |
| | Electrode | Openings | layer | White side | Black side |
| Comp. | ITO | Absent | Absent | 42.0 | 0.91 |
| Ex. 2 | Graphene | Present | Absent | 43.5 | 8.1 |
| Ex. 4 | Graphene | Present | Present | 41.8 | 2.2 |

As shown in Table 3, the reflectance at the white side in Example 2 is higher than that in Comparative Example. However, the reflectance at the black side in Example 2 is significantly increased, which results in a decreased contrast in the display section. This may be because of aggregation of the electrophoresis particles on graphene when the electrophoresis element is driven. A cause of the aggregation may be that the electrophoresis particles are configured such that the graphene electrode is directly contacted with the electrophoresis particles. On the other hand, an increase in the reflectance at the black side in Example 4 is significantly inhibited as compared to Example 2. This may be because the Nafion film disposed on the graphene electrode suppresses the reflection at the interface and becomes the protection layer for the graphene electrode, whereby the aggregation of the electrophoresis particles on the graphene electrode is inhibited.

While the present invention is described herein with reference to illustrative embodiments for particular applications, it should be understood that the invention is not limited thereto.

For example, the numerical values, the structures, the configurations, the shapes, the materials etc. shown in the above-described embodiments and examples are only illustrative, numerical values, structures, configurations, shapes, materials etc. different from those may be used as necessary.

The present disclosure may have the following configurations.

[1] An electrophoresis element, including:

a first base material;

a second base material disposed facing to the first base material;

insulation liquid layers disposed between the first base material and the second base material;

a porous layer disposed in the insulation liquid layers; and

electrophoresis particles disposed in the insulation liquid layers,

at least one of the first base material and the second base material having a light transmittance, graphene being disposed on at least a part of the surface of one of the first base material and the second base material having the light transmittance that is in contact with the insulation liquid layers.

[2] The electrophoresis element according to [1] above, in which the graphene has at least one opening.

[3] The electrophoresis element according to [1] or [2] above, in which an antireflection layer is disposed on at least a part of the graphene.

[4] The electrophoresis element according to any of [1] to [3] above, in which pixel electrodes are disposed facing to the graphene via the insulation liquid layers.

[5] The electrophoresis element according to any of [1] to [4] above, in which the porous layer is disposed such that the insulation liquid layers are divided into a first insulation liquid layer and a second insulation liquid layer.

[6] The electrophoresis element according to any of [1] to [5] above, in which the first insulation liquid layer is in contact with a surface of the porous layer at a side facing to the first base material, and the second insulation liquid layer is in contact with a surface of the porous layer at a side facing to the second base material.

[7] The electrophoresis element according to any of [1] to [6] above, in which at least one through hole is disposed in the porous layer such that the first insulation liquid layer is capable of communicating with the second insulation liquid layer.

[8] The electrophoresis element according to [7] above, in which the through hole is configured such that electrophoresis particles are capable of passing through between the first insulation liquid layer and the second insulation liquid layer.

[9] The electrophoresis element according to any of [2] to [8] above, in which the openings are formed in a hexagon grid shape.

[10] The electrophoresis element according to any of [2] to [9] above, in which an aperture ratio of the graphene is 25% to 75%.

[11] The electrophoresis element according to any of [1] to [10] above, in which the graphene is doped graphene.

[12] The electrophoresis element according to [11] above, in which the doped graphene includes acceptor particles adsorbed on the graphene.

[13] The electrophoresis element according to [12] above, in which the acceptor particles are gold chloride.

[14] The electrophoresis element according to any of [1] to [13] above, in which the porous layer has non-migrating particles and fibrous structures, and the non-migrating particles have light reflection properties different from those of the electrophoresis particles.

[15] The electrophoresis element according to any of [1] to [14] above, in which a color filter is disposed between the graphene and the one having the light transmittance of the first base material and the second base material.

[16] A display apparatus, including at least one electrophoresis element, the electrophoresis element, including:

a first base material;

a second base material disposed facing to the first base material;

insulation liquid layers disposed between the first base material and the second base material;

a porous layer disposed in the insulation liquid layers; and

electrophoresis particles disposed in the insulation liquid layers,

at least one of the first base material and the second base material having a light transmittance, graphene being disposed on at least a part of the surface of one of the first base material and the second base material having the light transmittance that is in contact with the insulation liquid layers.

[17] An electronic device, including at least one electrophoresis element, the electrophoresis element, including:

a first base material;

a second base material disposed facing to the first base material;

insulation liquid layers disposed between the first base material and the second base material;

a porous layer disposed in the insulation liquid layers; and

electrophoresis particles disposed in the insulation liquid layers,

at least one of the first base material and the second base material having a light transmittance, graphene being disposed on at least a part of the surface of one of the first base material and the second base material having the light transmittance that is in contact with the insulation liquid layers.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An electrophoresis element, comprising:
a first base material;
a second base material disposed facing to the first base material;
insulation liquid layers disposed between the first base material and the second base material;
a porous layer disposed in the insulation liquid layers; and
electrophoresis particles disposed in the insulation liquid layers,
at least one of the first base material and the second base material having a light transmittance, graphene being disposed on at least a part of the surface of one of the first base material and the second base material having the light transmittance that is in contact with the insulation liquid layers.

2. The electrophoresis element according to claim 1, wherein the graphene has at least one opening.

3. The electrophoresis element according to claim 2, wherein an antireflection layer is disposed on at least a part of the graphene.

4. The electrophoresis element according to claim 3, wherein pixel electrodes are disposed facing to the graphene via the insulation liquid layers.

5. The electrophoresis element according to claim 4, wherein the porous layer is disposed such that the insulation liquid layers are divided into a first insulation liquid layer and a second insulation liquid layer.

6. The electrophoresis element according to claim 5, wherein the first insulation liquid layer is in contact with a surface of the porous layer at a side facing to the first base material, and the second insulation liquid layer is in contact with a surface of the porous layer at a side facing to the second base material.

7. The electrophoresis element according to claim 6, wherein at least one through hole is disposed in the porous layer such that the first insulation liquid layer is capable of communicating with the second insulation liquid layer.

8. The electrophoresis element according to claim 7, wherein the through hole is configured such that electrophoresis particles are capable of passing through between the first insulation liquid layer and the second insulation liquid layer.

9. The electrophoresis element according to claim 2, wherein the openings are formed in a hexagon grid shape.

10. The electrophoresis element according to claim 9, wherein an aperture ratio of the graphene is 25% to 75%.

11. The electrophoresis element according to claim 10, in which the graphene is doped graphene.

12. The electrophoresis element according to claim 11, wherein the doped graphene includes acceptor particles adsorbed on the graphene.

13. The electrophoresis element according to claim 12, wherein the acceptor particles are gold chloride.

14. The electrophoresis element according to claim 1, wherein the porous layer has non-migrating particles and fibrous structures, and the non-migrating particles have light reflection properties different from those of the electrophoresis particles.

15. The electrophoresis element according to claim 1, wherein a color filter is disposed between the graphene and the one having the light transmittance of the first base material and the second base material.

16. A display apparatus including at least one electrophoresis element, the electrophoresis element, comprising:
a first base material;
a second base material disposed facing to the first base material;
insulation liquid layers disposed between the first base material and the second base material;
a porous layer disposed in the insulation liquid layers; and
electrophoresis particles disposed in the insulation liquid layers,
at least one of the first base material and the second base material having a light transmittance, graphene being disposed on at least a part of the surface of one of the first base material and the second base material having the light transmittance that is in contact with the insulation liquid layers.

17. An electronic device including at least one electrophoresis element, the electrophoresis element, comprising:
a first base material;
a second base material disposed facing to the first base material;
insulation liquid layers disposed between the first base material and the second base material;
a porous layer disposed in the insulation liquid layers; and
electrophoresis particles disposed in the insulation liquid layers,
at least one of the first base material and the second base material having a light transmittance, graphene being disposed on at least a part of the surface of one of the first base material and the second base material having the light transmittance that is in contact with the insulation liquid layers.
